(19) United States
(12) Patent Application Publication
(10) Pub. No.: US 2022/0209629 A1
(43) Pub. Date: Jun. 30, 2022

(54) MAGNETIC SHIELD FOR POSITION SENSOR

(71) Applicant: BorgWarmer Inc., Auburn Hills, MI (US)

(72) Inventors: James C. Bach, Westfield, IN (US); John Meyer, McCordsville, IN (US); German Holguin Pallares, Noblesville, IN (US)

(21) Appl. No.: 17/134,629

(22) Filed: Dec. 28, 2020

(51) Int. Cl. H02K 11/02; H02K 9/22; H02K 11/215; H02K 11/33; H02K 21/14

(52) U.S. Cl. CPC H02K 11/02; H02K 9/227; H02K 2211/03; H02K 11/33; H02K 21/14; H02K 11/215

(57) ABSTRACT

A rotating electric machine with a rotor shaft having a target magnet. High current conductors conductively couples inverter circuitry with the stator windings. Control circuitry and a magnetic position sensor facing the target magnet are disposed on a printed circuit board, the printed circuit board being axially positioned between the target magnet and a heat sink. The high current conductors extend axially from proximate the heat sink to the stator assembly and are positioned radially outwardly of the magnetic position sensor. A ferrous shield member has a major surface defining a plane perpendicular to the rotational axis. The magnetic position sensor is axially disposed between the shield member and the target magnet and the shield member is positioned between the printed circuit board and the heat sink. The shield member has a surface area covering most of the area radially inward of the high current conductors.

### BACKGROUND

Rotating electric machines (commonly referred to as motors, generators, or motor/generator units) having integrated control and drive electronics (commonly referred to as inverters) will often employ a magnetic sensor to sense the rotational position of the rotating electric machine's shaft. The signals generated by the magnetic position sensor are communicated to the control unit (typically a microprocessor within the inverter executing a control algorithm) which controls the operation of the rotating electric machine via the inverter's onboard circuitry.

The phase leads connecting the power modules of the inverter circuitry with the stator windings of the rotating electric machine and the bus bars feeding DC electrical current to the power modules of the inverter circuitry are often in close proximity to the magnetic position sensor. These high-current electrical conduction pathways can generate stray magnetic fields which interfere with the correct operation of the magnetic sensor.

This electromagnetic interference can cause a superimposed angular “dither” on the position (angle) reported by the magnetic position sensor thereby creating periodic angular inaccuracies being reported to the control unit. These inaccuracies can, in turn, cause the control circuitry to impart a periodic ripple in the torque and/or speed of the rotating electric machine being controlled thereby creating noise, vibration and/or harshness issues.

To limit such interference, it is known to mount a small ferrous steel cap on the heat sink which has a shape generally similar to a bottle cap whereby the magnetic position sensor is positioned between the cap and a magnet positioned on the end of the rotating electric machine's shaft. An aluminum heat sink is typically provided and is used to absorb heat generated by the power modules of the inverter circuitry and often also other components within the inverter's circuitry. While aluminum is electrically conductive it is non-ferrous and thus does not influence the stray magnetic fields. Such caps are sometimes referred to as magnetic concentrators and it is thought that the primary purpose of such caps is to increase and/or straighten the flux lines of the target magnet on the shaft's end through the sensing element (typically a plurality of Hall Effect plates) of the magnetic position sensor by drawing such fields from the magnet through the magnetic position sensor to the cap. The size of the concentrator is such that it provides only minimal if any magnetic shielding from undesirable stray magnetic fields.

By increasing the desired flux of the target magnet at the magnetic position sensor, this can increase the signal (flux generated by the target magnet) to noise (stray magnetic field flux) ratio at the magnetic position sensor, thus reducing the impact of stray fields on the sensing element. If the combined magnetic flux of both the signal (flux generated by the target magnet) and noise (flux generated by stray magnetic fields) becomes too great, however, this can saturate or over-flux the sensing element of the sensor and thereby degrade the performance (e.g. angular accuracy) of the sensor. When the rotating electric machine is operating at relatively high current loads, the electrical currents that generate the undesirable stray magnetic fields will be at their greatest and thereby most likely to over-flux a magnetic position sensor employing a flux concentrating cap.

An example of such a prior art flux concentrating cap is shown in FIGS. 1-5. FIG. 1 is a photograph of a prior art flux concentrating cap 2 mounted on a heat sink 4. Flux concentrating cap 2 is formed out of a ferrous steel material while heat sink 4 is formed out of a non-ferrous material (aluminum in this example). The three openings 3 in heat sink 4 allow for the passage of bus bars (a.k.a. phase leads) connecting the power modules of an inverter to the stator windings of the rotating electric machine. FIG. 2 is a photograph of the heat sink 4 showing the depression in which the flux concentrating cap 2 was mounted. The dark sections within the depression are the adhesive used to secure the cap 2. FIG. 3 is a photograph of the flux concentrating cap 2 from the top side. FIG. 4 is a photograph of cap 2 from the bottom side showing the adhesive used to secure the cap 2 to the heat sink 4. FIG. 5 is a cross sectional drawing showing the flux concentrating cap 2, a magnetic position sensor 6 mounted on the inverter's printed circuit board 7, and a target magnet 8 which would be mounted in a non-ferrous (e.g., aluminum) holder which is coupled with the end of a rotor shaft to prevent the ferrous shaft from interfering with the magnetic flux lines of the target magnet.

Improvements in rotating electric machine design that provide for the improved performance of magnetic position sensors in the presence of stray electromagnetic fields remain desirable.

### SUMMARY

The present invention provides a rotating electric machine and integrated inverter having a shield member that reduces the stray magnetic fields interfering with a magnetic position sensor used to sense the rotational position (angle) of the rotor shaft.

The invention comprises, in one form thereof, a rotating electric machine that includes a stator assembly including a stator core and a plurality of stator windings; a rotor assembly including a rotor mounted on a rotor shaft, the rotor shaft and rotor being rotatable relative to the stator assembly about a rotor axis; a target magnet mounted on a proximal end of the rotor shaft; inverter circuitry adapted to convert electrical current between DC electrical current and AC electrical current wherein the inverter circuitry is conductively coupled with the plurality of stator windings through a plurality of high current conductors; control circuitry mounted on a printed circuit board and controlling operation of the inverter circuitry; a non-ferrous heat sink, the heat sink being thermally coupled with select components of the inverter circuitry; a magnetic position sensor mounted on the printed circuit board facing the target magnet to thereby sense the rotational position (angle) of the target magnet during operation of the rotating electric machine; wherein the printed circuit board is axially positioned between the target magnet and the heat sink and the plurality of high current conductors extend axially from proximate the heat sink to the stator assembly and are positioned radially outwardly of the magnetic position sensor and angularly distributed about the rotational axis; a shield member formed out of a ferrous sheet material and having a major surface defining an axial plane perpendicular to the rotational axis and a first surface area wherein the printed circuit board and magnetic position sensor mounted thereon are axially disposed between the shield member and the target magnet and wherein the shield member is disposed proximate the printed circuit board and is axially disposed between the printed circuit board and at least a portion of the heat sink; and wherein the plurality of high current conductors each define a radially inward facing surface wherein a circle drawn in the axial plane, concentric with the rotational axis and having a radius equal to a distance between the rotational axis and a nearest one of the radially inward facing surfaces of the plurality of high current conductors defines a second surface area, the first surface area being at least as great as 50% of the second surface area.

In such a rotating electric machine, the axial plane of the shield member may be positioned between a main body of the heat sink and the printed circuit board.

In some embodiments, the shield member may define a plurality of openings with the heat sink defining a plurality of pedestals axially extending from the main body through the plurality of openings in the shield member, each of the pedestals being thermally coupled with one or more electrical components on the printed circuit board (PCB).

In some embodiments, the outer perimeter of the shield member defines a circle having a first diameter and wherein the circle defined by the radially inward facing surfaces of the plurality of high current conductors defines a second diameter, the first diameter being at least as great as 85% of the second diameter.

In some embodiments, the shield member is a flat planar member axially spaced from the main body of the heat sink.

In some embodiments, the main body of the heat sink defines a recess with the shield member being at least partially disposed in the recess. In such embodiments, the shield member may include a planar first portion disposed in the axial plane and a second portion axially displaced from the first portion toward the magnetic position sensor, the first portion being disposed in the recess and the second portion being at least partially disposed outside the recess and wherein the second portion, the target magnet and the magnetic position sensor are all positioned concentrically with the rotational axis and axially spaced apart from each other with the magnetic position sensor being disposed between the second portion and the target magnet. In such an embodiment, the first portion of the shield member may form a majority of the shield member.

In some embodiments, the shield member is secured to the heat sink.

In some embodiments, the shield member has a thickness within the range of 0.5 mm to 2.5 mm.

The shield member may be formed out of a variety of materials including a carbon steel having a carbon content up to 2.1% (by weight), an electrical steel having a silicon content within the range of 1% to 6.5% (by weight) or a permalloy comprising both nickel and iron. For example, the shield member may be a cold-rolled low-carbon steel having a carbon content within the range of 0.15% to 0.20% (by weight) such as AISI 1081 cold-rolled steel. Such a low-carbon steel shield may have a thickness within the range of 0.5 mm and 2.5 mm.

The invention comprises, in another form thereof, a rotating electric machine that includes a stator assembly including a stator core and a plurality of stator windings; a rotor assembly including a rotor mounted on a rotor shaft, the rotor shaft and rotor being rotatable relative to the stator assembly about a rotor axis; a target magnet mounted on a proximal end of the rotor shaft; inverter circuitry adapted to convert electrical current between DC electrical current and AC electrical current wherein the inverter circuitry is conductively coupled with the plurality of stator windings through a plurality of high current conductors; control circuitry mounted on a printed circuit board and controlling operation of the inverter circuitry; a non-ferrous heat sink, the heat sink being thermally coupled with the inverter circuitry; a magnetic position sensor mounted on the printed circuit board facing the target magnet to thereby sense the rotational position of the target magnet during operation of the rotating electric machine; wherein the printed circuit board is axially positioned between the target magnet and the heat sink and the plurality of high current conductors extend axially from proximate the heat sink to the stator assembly and are positioned radially outwardly of the magnetic position sensor and angularly distributed about the rotational axis; a shield member formed out of a ferrous sheet material and having a major surface defining an axial plane perpendicular to the rotational axis and a first surface area wherein the printed circuit board and magnetic position sensor mounted thereon are axially disposed between the shield member and the target magnet and wherein the shield member is disposed proximate the printed circuit board and axially disposed between the printed circuit board and at least a portion of the heat sink; and wherein the shield member includes a planar first portion disposed in the axial plane and a second portion axially displaced from the first portion toward the magnetic position sensor, the first portion of the shield member forming a majority of the shield member and wherein the second portion, the target magnet and the magnetic position sensor are all positioned concentrically with the rotational axis and axially spaced apart from each other with the magnetic position sensor being disposed between the second portion and the target magnet.

In such a rotating electric machine, the first portion of the shield member may define a plurality of openings with the heat sink defining a plurality of pedestals axially extending from the main body through the plurality of openings in the shield member, each of the pedestals being thermally coupled with one or more electrical components mounted on the printed circuit board (PCB). The outer perimeter of the first portion of the shield member may also define a first circle having a first diameter and the plurality of high current conductors each define a radially inward facing surface wherein a second circle drawn in the axial plane, concentric with the rotational axis and connecting each of the radially inward facing surfaces of the plurality of high current conductors defines a second diameter, the first diameter being at least as great as 85% of the second diameter. The second circle may also define a second surface area wherein the first surface area is at least as great as 50% of the second surface area. Further, the main body of the heat sink may also define a recess wherein the first portion of the shield member is disposed in the recess and at least a portion of the second portion of the shield member is disposed outside the recess.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a photograph of a prior art heat sink and flux concentrating cap.

FIG. 2 is a photograph of the prior art heat sink of FIG. 1 with the cap removed.

FIG. 3 is a photograph of the prior art cap of FIG. 1, viewed from the top.

FIG. 4 is another photograph of the prior art cap of FIG. 1, viewed from the bottom.

FIG. 5 is cross sectional view of the prior art assembly of FIG. 1.

FIG. 6 is a partial view of a rotating electric machine assembly including the target magnet, magnetic position sensor, and shield member.

FIG. 7 is a partial perspective view of the high current conduction pathways of a rotating electric machine assembly including the target magnet, magnetic position sensor, and shield member.

FIG. 8 is a top view of a rotating electric machine assembly including a shield member.

FIG. 9 is a chart showing the performance of several different shield members.

FIG. 10 is a cross sectional view of a rotating electric machine assembly showing the primary elements of the rotating electric machine.

FIG. 11 is a perspective view showing a heat sink and inverter circuitry.

FIG. 12 is a cross sectional view showing a heat sink, magnetic position sensing subsystem (magnet and sensor), magnetic shield member and rotor shaft.

FIG. 13 is a cross sectional perspective view showing a heat sink, magnetic position sensing subsystem (magnet and sensor), magnetic shield member and rotor shaft.

FIG. 14 is another cross sectional perspective view showing a heat sink, magnetic position sensing subsystem (magnet and sensor), magnetic shield member and rotor shaft.

FIG. 15 is a perspective view showing the magnetic shield member and heat sink.

FIG. 16 is a perspective view of another embodiment showing a heat sink, magnetic shield member and inverter circuitry (power modules).

FIG. 17 is a perspective view showing a heat sink, inverter power modules, and DC-Link capacitor bank bus bar plates.

FIG. 18 is a perspective view showing a magnetic shield member, heat sink and inverter circuitry (power modules).

FIG. 19 is a view of a printed circuit board.

FIG. 20 is an end view showing a magnetic shield member and heat sink and also indicating where the electronic components on the printed circuit board are located.

FIG. 21 is an enlarged detail view of FIG. 20.

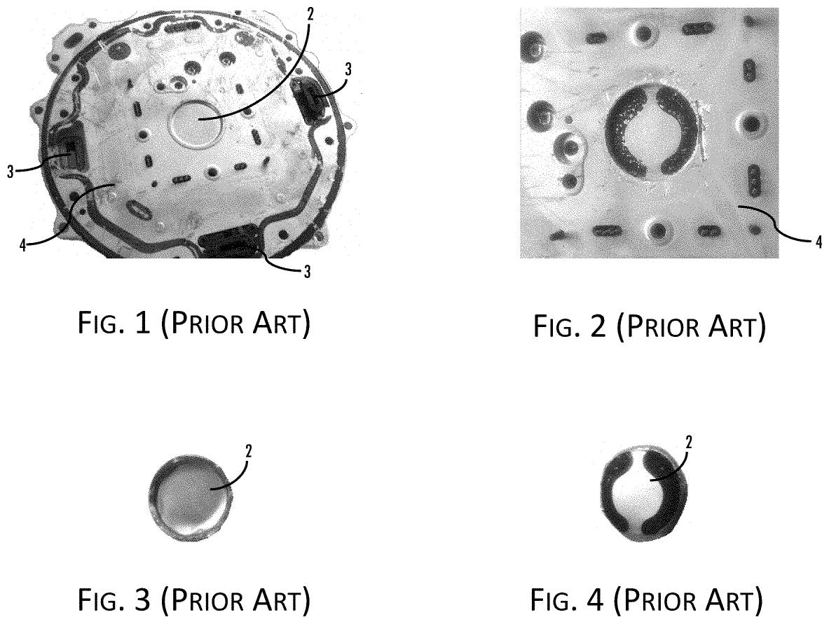

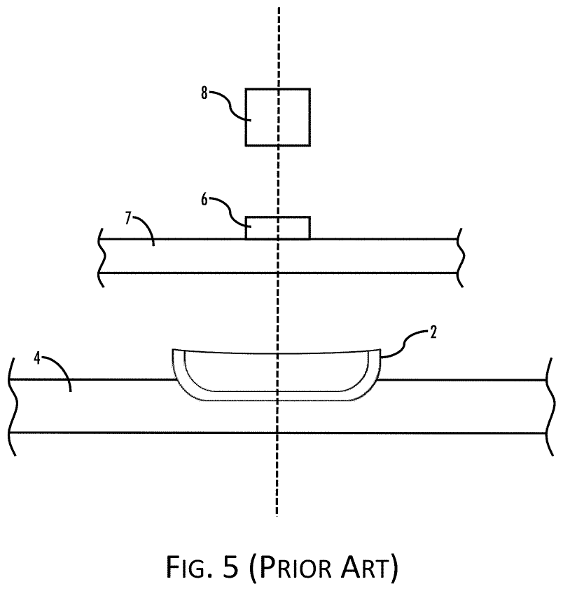

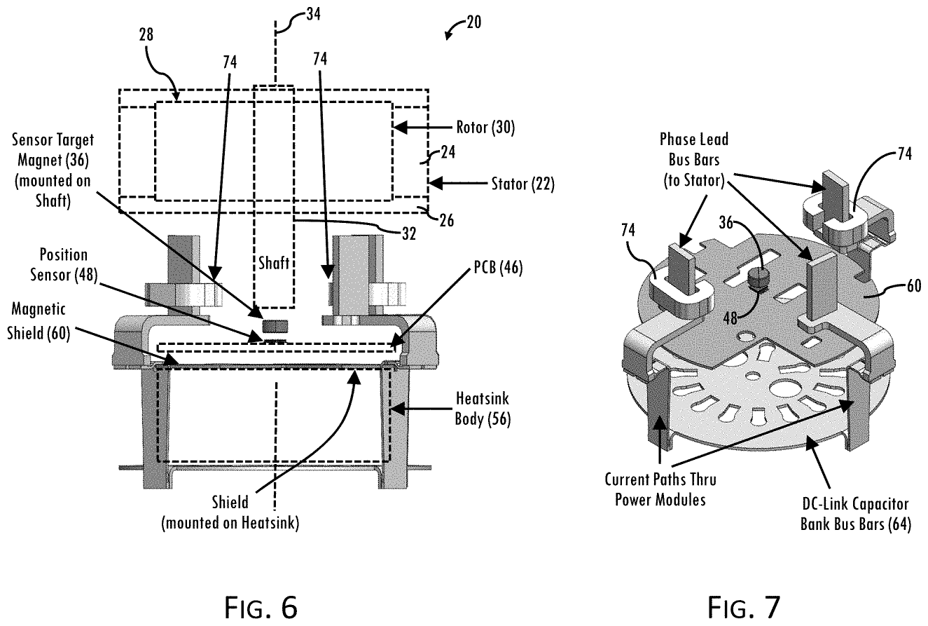

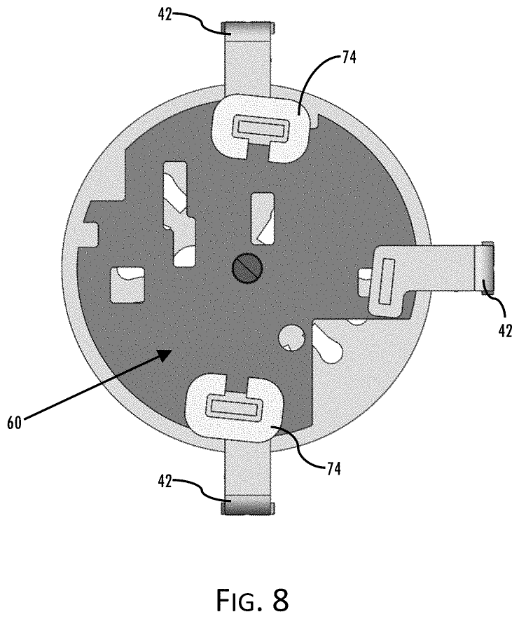

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

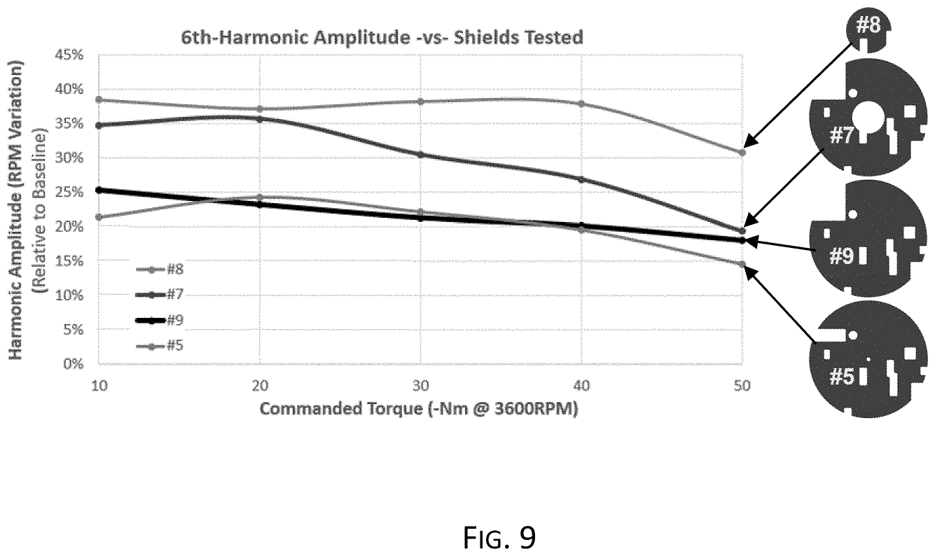

A rotating electric machine 20 is shown in FIG. 6 and includes a stator assembly 22 having a stator core 24 and a plurality of stator windings 26. In the illustrated embodiment, rotating electric machine 20 is a multi-phase rotating electric machine having a separate stator winding for each phase, e.g., a three phase rotating electric machine. A rotor assembly 28 has a rotor 30 mounted on a rotor shaft 32. Rotor 30 and rotor shaft 32 rotate about rotor axis 34 relative to the stator assembly 22 and the other major components of rotating electric machine 20. In the illustrated embodiment, rotor 30 takes the form of a rotor core with a plurality of permanent magnets mounted thereon.

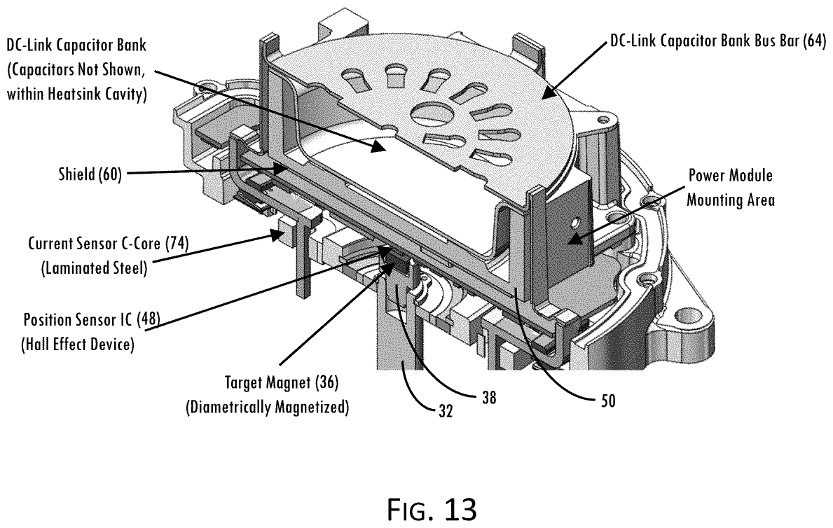

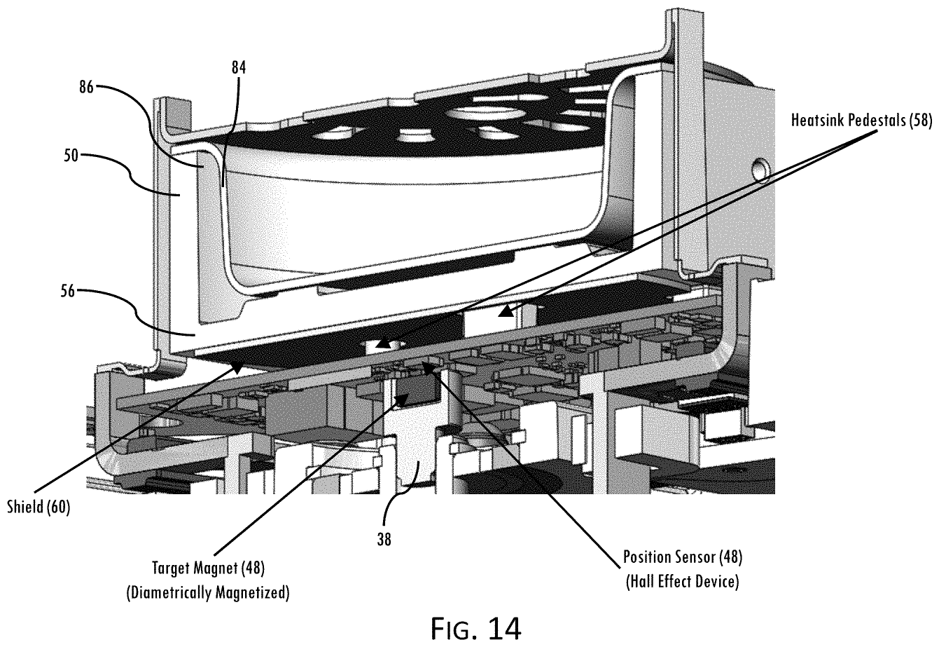

A target magnet 36 is mounted on a proximal end of rotor shaft 32. As can be seen in FIGS. 10, 13 and 14, target magnet 36 is mounted in a non-ferrous magnet holder 38. Target magnet 36 is cylindrical in shape and diametrically magnetized. In other words, a cross section of target magnet 36 taken perpendicular to rotational axis 34 would be a circle wherein a diametrical line would divide that circle into two equal semi-circles with the two semi-circles having the opposite magnetic polarity. In the illustrated embodiment, shaft 32 is formed out of a steel material and magnet holder 38 is formed out of a non-ferrous material, such as aluminum, to avoid interfering with the magnetic field generated by the target magnet. If shaft 32 were formed out of a non-ferrous material, target magnet 36 could be mounted directly therein. As further discussed below, target magnet 36, in conjunction with magnetic position sensor 48, is used to determine the rotational position of shaft 32 and rotor 30 mounted thereon.

Rotating electric machine 20 also includes inverter circuitry 40. Inverter circuitry 40 converts electrical current between direct current (DC) and alternating current (AC) and is conductively coupled with stator windings 26 through a plurality of high current conductors 42 which take the form of bus bars in the illustrated embodiment. In the illustrated embodiment, rotating electric machine 20 is a motor-generator and can be operated as a motor or a generator. For example, rotating electric machine 20 is suitable for use in a hybrid vehicle. When operating as a motor, inverter circuitry 40 converts DC electrical current from a DC power source such as a vehicle battery or battery pack to AC electrical current which is then supplied to stator windings 26 to operate the rotating electric machine 20 as a motor, delivering rotational energy to the drive system. When operating as a generator, vehicle drive system energy in the form of a torque is applied to rotor shaft 32 and AC electrical current is generated in stator windings 26. This AC current is then rectified to DC electrical current by inverter circuitry 40 to charge a battery pack or for other suitable purposes.

In the illustrated embodiment, circuitry 40 provides a pulse width modulated voltage source inverter, wherein a pair of switched power semiconductor devices are used with each phase of the rotating electric machine and are located in power modules 52 between the electric motor and a direct current (DC) voltage source. These power semiconductor devices act as switches and are controlled by control circuitry 44 to open and close in order to synthesize a desired voltage waveform thereby controlling the flow of electrical current within the phases of the rotating electric machine. This technique of opening and closing the power semiconductor devices to synthesize a desired voltage waveform and/or current waveform is generally referred to as pulse-width modulation (PWM). In the illustrated embodiment, power modules 52 use field effect transistors (FETs) as the power semiconductor devices. Various other devices, such as insulated-gate bipolar transistors (IGBTs), bipolar junction transistors, such as NPN or PNP transistors, may also be used as the power semiconductor devices. Inverter circuitry 40 also includes a bank of DC-link capacitors 54 which supply DC electrical current to power modules 52 when rotating electric machine 20 is operating as a motor. A DC bus bar 64 is used to connect capacitors 54 with power modules 52. The use of such PWM modulated inverter circuitry with rotating electric machines is well known in the art. Because rotating electric machine 20 is a three phase rotating electric machine, inverter circuitry 40 includes three separate power modules 52, one for each of the three different phases.

DC-link capacitors 54 are used to provide a stable DC voltage to power modules 52 and coupled with power modules 52 with DC link bus bar 64. Bus bar 64 is a multi-layer bus bar, with one layer being connected to a positive terminal of the DC voltage source, an intermediate insulating layer and a third layer being connected to the negative terminal of the DC voltage source. As best seen in FIG. 17, each of the plurality of capacitors 54 have leads 76 that extend through and are welded to the appropriate layer in the DC bus bar to form an electrical connection. Threaded bores 78 in DC bus bar 64 are engaged with threaded conducting members to provide a connection with the voltage source and welding tabs 80 are used to electrically couple DC bus bar 64 with power modules 52. As best seen in FIGS. 12-14, capacitors 54 are disposed in a metal enclosure within the interior of heat sink 50.

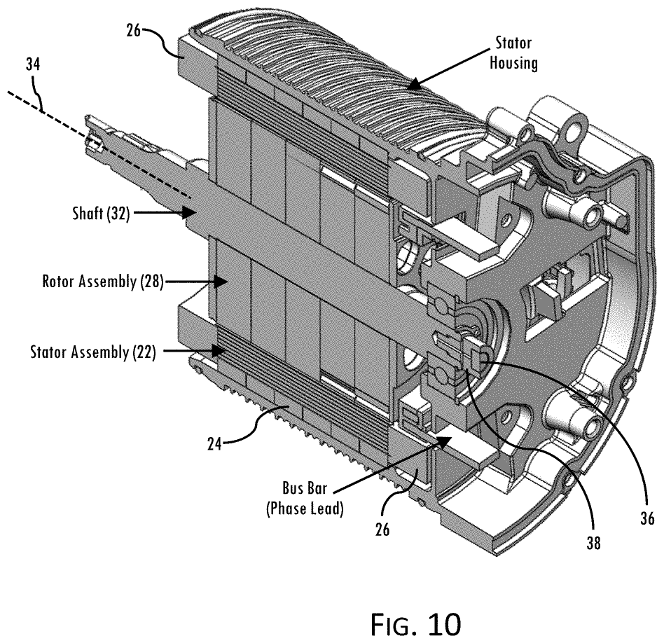

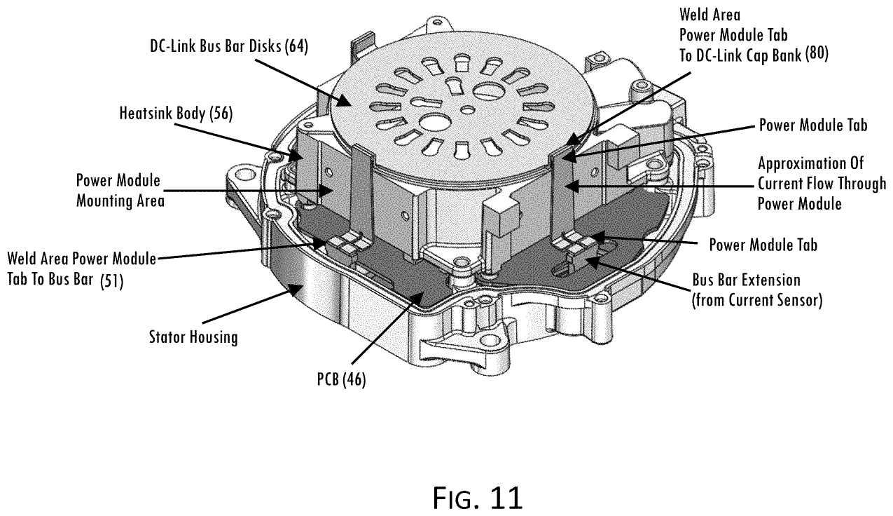

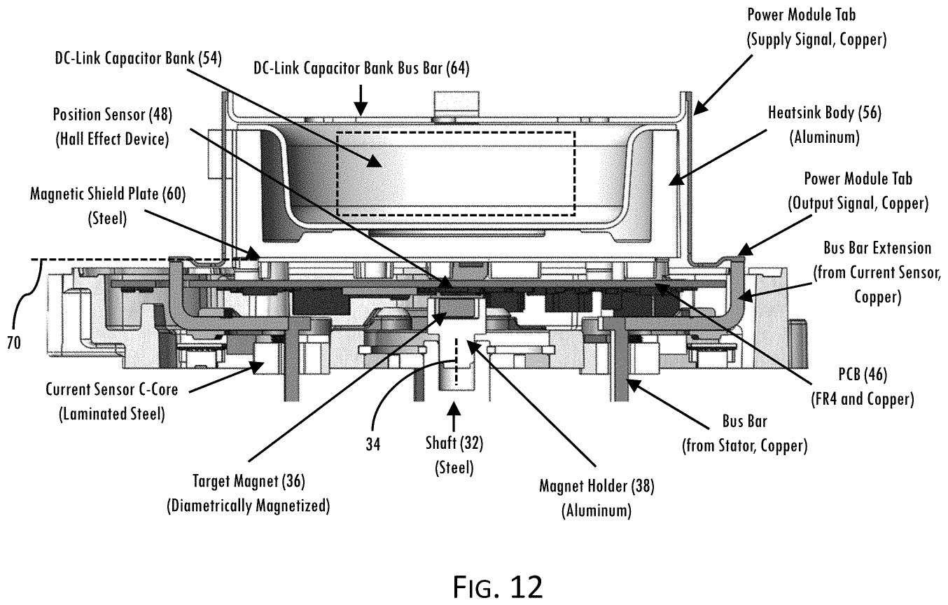

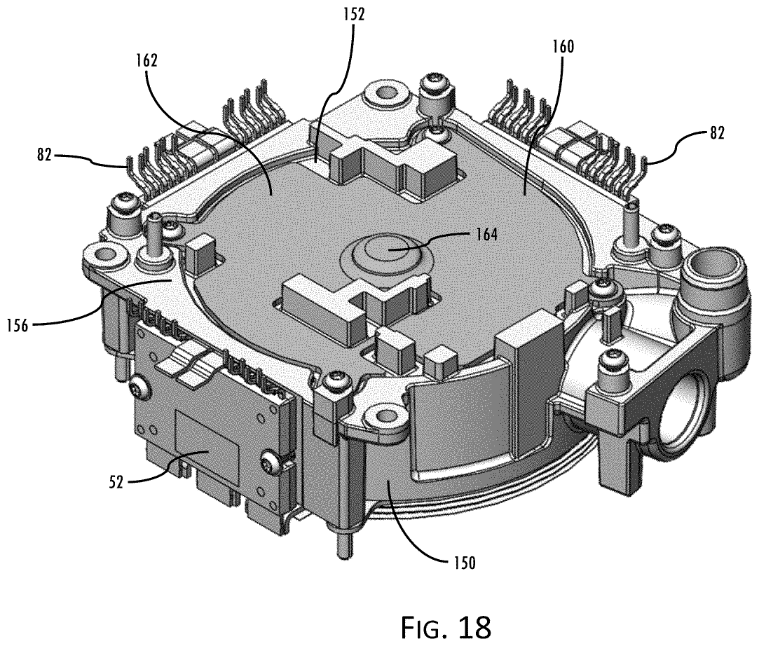

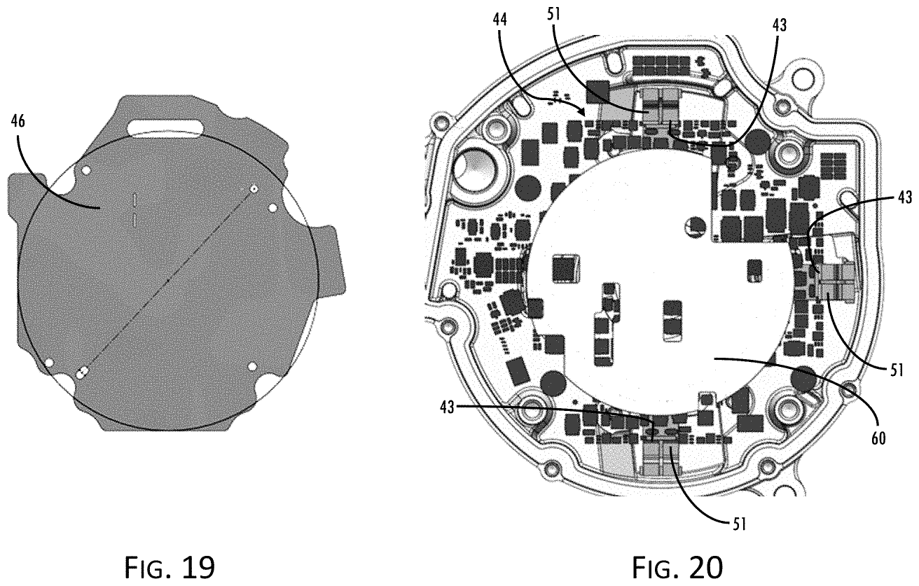

Control circuitry 44 which controls the operation of inverter circuitry 40 and rotating electric machine 20 is disposed on printed circuit board 46. As best seen in FIGS. 17 and 18 control signal pins 82 are used to communicate electrical signals between control circuitry 44 and inverter circuitry 40 (which includes power modules 52). FIG. 19 shows the outline of the printed circuit board 46 and FIG. 20 is a view that omits the circuit board itself but shows the circuit components, including control circuitry 44 (components shown in black), that are mounted on printed circuit board 46. Also shown in FIG. 20 is shield member 60 and how openings 62 in shield member 60 correspond to particular circuit components mounted on printed circuit board 46. In the illustrated embodiment, printed circuit board 46 also includes circuitry that is coupled with C-cores 74 for sensing the current in two of the bus bars coupled with the stator windings. These C-cores are formed out of a stack of electrical steel laminations and are best seen in FIGS. 7 and 8. A magnetic position sensor 48 is also mounted on printed circuit board 46. Magnetic position sensor 48 is axially spaced from target magnet 36 and positioned facing and sufficiently close to target magnet 36 that it can detect the magnetic field generated by target magnet 36.

In the illustrated embodiment, magnetic position sensor 48 is a circular, vertical Hall sensor having 64 Hall Effect plates arranged in a small circle within the integrated circuit (IC) forming the magnetic position sensor 48 which is mounted on the printed circuit board 46. Other magnetic position sensors having alternative designs and lesser or greater resolution may also be used with rotating electric machine 20; for instance, a magnetic sensor could simply have 4 Hall Effect plates arranged in an X-Y grid. Alternative forms of magnetic position sensors may also be advantageously used with the present disclosure. For example, anisotropic magnetoresistance (AMR), geometrical magnetoresistance (GMR), and tunnel magnetoresistance (TMR) sensors may alternatively be used.

The individual Hall plates of magnetic position sensor 48 detect changes in magnetic flux and by comparing the readings of the different plates, a logic circuit can determine the rotational position of target magnet 36. Once the rotational position of target magnet 36 is known, the rotational position of shaft 32 and rotor 30 can then be determined during operation of rotating electric machine 20. The position of rotor 30 determines the relative angular positions of the permanent magnets mounted therein and is used in the control of rotating electric machine 20 and inverter circuitry 40 during operation of rotating electric machine 20. The use and operation of a Hall Effect sensor to determine a rotational position of a shaft is well-known in the art.

The location of magnetic position sensor 48 in rotating electric machine 20 subjects it to potential interference due to the large electrical currents being generated during operation of rotating electric machine 20. The electrical current being conducted through conductors 42 is a relatively high current load compared to the much smaller electrical signals communicated on printed circuit board 46 and the electrical current in high current conductors 42 is capable of generating stray magnetic fields that interfere with the proper operation of magnetic position sensor 48.

When electricity flows along a linear path defined by a conductor it creates a circular or cylindrical magnetic field around the conductor according to the right-hand rule as is well-known to those having ordinary skill in the art. As a result, axially extending lengths of high current conductors 42 are primarily responsible for generating stray magnetic fields that may interfere with the proper operation of magnetic position sensor 48. As further discussed below, shield member 60 is used to reduce this interference by stray magnetic fields.

Rotating electric machine 20 also includes a non-ferrous heat sink 50. In the illustrated embodiment, heat sink 50 is an aluminum heat sink. Power modules 52 are the main heat generating components of inverter circuitry 40 and are mounted on the outer radial sides of heat sink 50 to thereby thermally couple power modules 52 with heat sink 50. Heat sink 50 defines an open space in which the bank of capacitors 54 are disposed. Capacitors 54 may be thermally coupled with heat sink 50 indirectly or by being mounted on a metal sheet or other thermally conductive material attached to heat sink 50. Heat sink 50 has a relatively large mass for absorbing heat generated by both the power modules 52 and capacitors 54. Heat sink 50 then dissipates the absorbed thermal energy to a liquid coolant or the ambient air. In the illustrated embodiment, heat sink 50 is liquid cooled. A thin sheet metal housing member 84 is coupled with main body 56 of heat sink 50 to define a fluid tight interior space 86 through which a liquid coolant, such as a water-ethylene-glycol mixture commonly referred to as anti-freeze, is circulated. The liquid coolant is introduce and discharged from interior space 86 through liquid ports 88 to an external liquid coolant system, e.g., the coolant system of a vehicle. Alternatively, the heat sink may be air-cooled. For example, a fan may be used to generate an air flow that cools the heat sink.

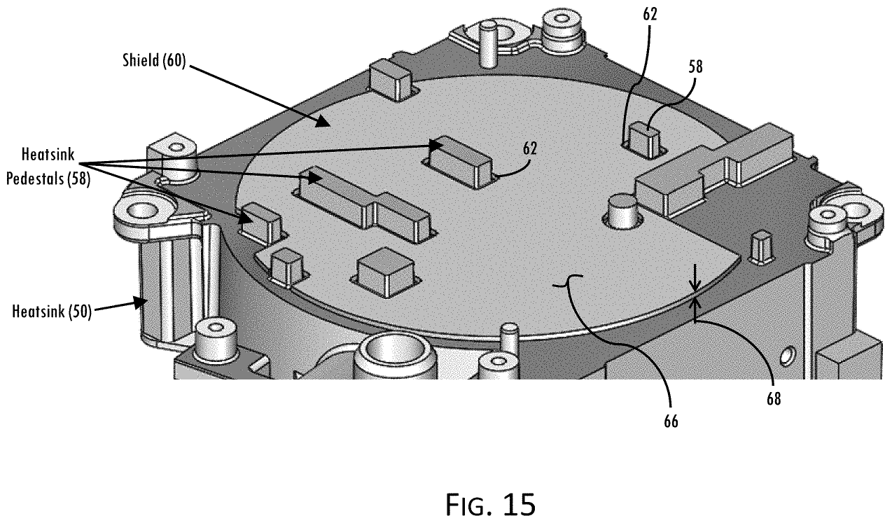

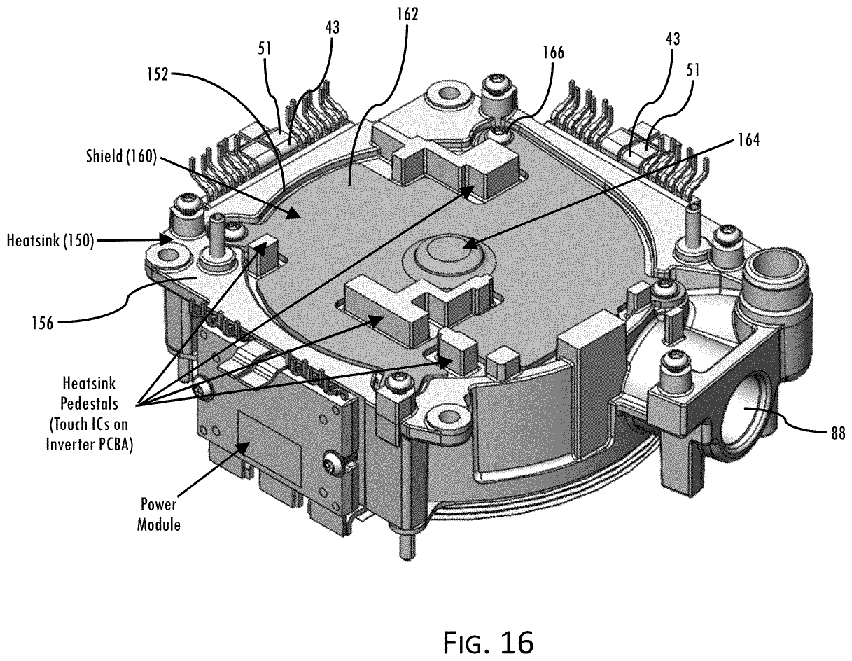

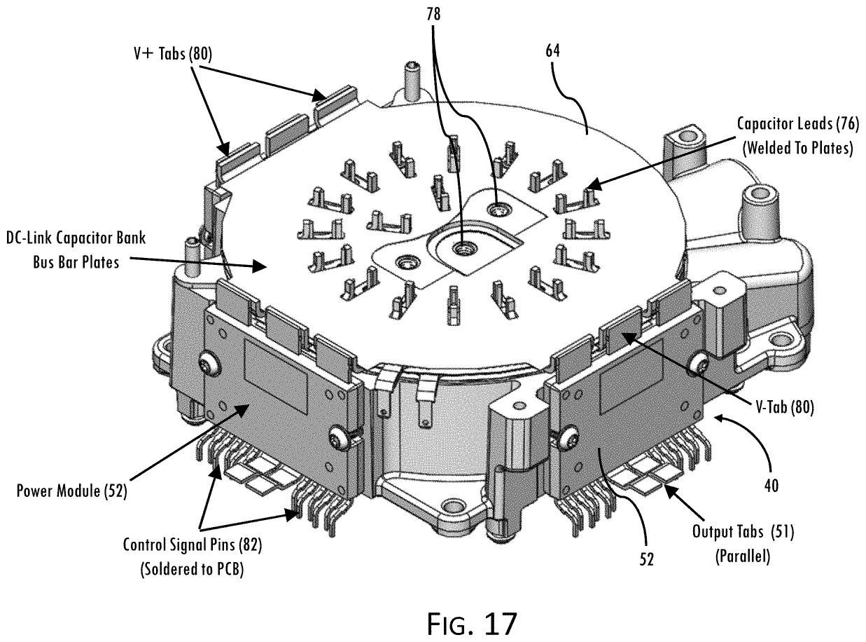

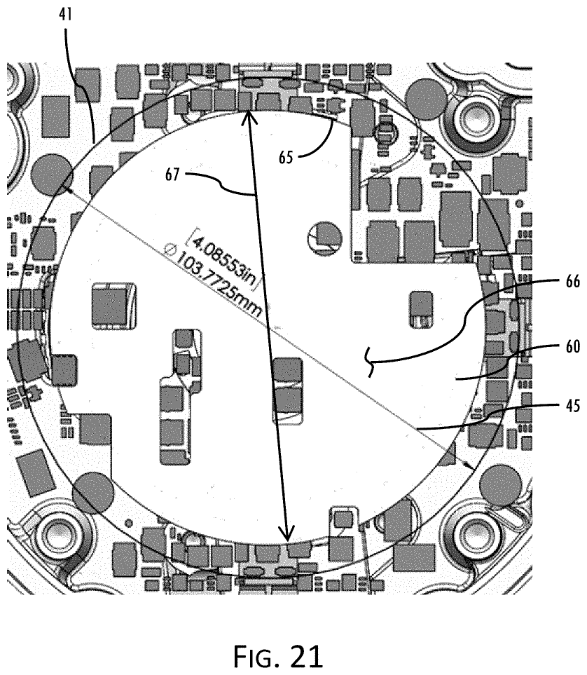

In the illustrated embodiment, heat sink 50 is not only thermally coupled with power modules 52 of the inverter circuitry 40 but also thermally coupled with particular electrical components (devices) mounted on printed circuit board 46. Heat sink 50 includes a main body 56 which is thermally coupled with power modules 52 and also includes a plurality of pedestals 58 which project from the main body 56 in an axial direction toward the printed circuit board 46. Pedestals 58 extend through openings 62 in shield member 60 to thermally couple with printed circuit board 46 whereby the pedestals absorb thermal energy from the printed circuit board 46. FIGS. 15 and 16 illustrate how pedestals 58 project through openings in the shield member. Pedestals 58 are thermally coupled to particular components (devices) mounted on printed circuit board 46 with a thermally conductive paste, adhesive, pad or other suitable substance at locations where there are circuit components that generate significant thermal energy during operation as can be readily understood with reference to FIGS. 20 and 21.

Shield member 60 is formed out of a ferrous sheet material having two opposing major surfaces and defining a thickness 68 between the two major surfaces. Shield member 60 is positioned so that a major surface 66 of shield member 60 defines an axial plane 70 oriented perpendicular to rotational axis 38. (As used herein, the phrase axial plane refers to a plane that is oriented perpendicular to the rotational axis of the rotating electric machine.) The opposing major surface of shield 60 will be substantially parallel with axial plane 70 and offset by the thickness of shield 60. In this regard, it is noted that small deviations from a precise 90 degree angle between the major surface 66 of shield member 60 and rotational axis 38 are still considered perpendicular as used herein.

Printed circuit board 46 and magnetic position sensor 48 mounted thereon are axially disposed between shield member 60 and target magnet 36. Axial plane 70 defined by shield 60 is disposed between printed circuit board 46 and magnetic position sensor 48 mounted thereon on one side of axial plane 70 and inverter circuitry 40 on the other side of axial plane 70. In the illustrated embodiment, power modules 52 are disposed radially outwardly of shield 60 while capacitors 54 are spaced from rotational axis 36 by no more than the outer perimeter of shield member 60.

In the illustrated embodiment, shield member 60 is secured to heat sink 50. Shield member 60 may be secured such that it is axially spaced from heat sink 50 except for a limited number of discrete points of attachment. For example, heat sink 50 may include attachment bosses that axially extend toward the printed circuit board and define discrete attachment points for shield member 60. Alternatively, shield member 60 could be directly engaged with a planar surface of heat sink 50 for a substantial majority of the adjacent major surface of shield member 60. Shield member 60 can be attached using any suitable method including the use of adhesives and/or fasteners. For example, a one-part self-curing liquid, a two-sided adhesive film or other suitable adhesive could be employed or threaded fasteners, rivets, nuts and bolts, self-tapping screws or other suitable fasteners or some combination of attachment methods could be employed to secure shield member 60.

As mentioned above, shield member 60 is formed out of a ferrous sheet material. Suitable materials include carbon steels such as those having a carbon content up to 2.1% (by weight), electrical steels having a silicon content within the range of 1% to 6.5% (by weight) and a permalloy material that includes both nickel and iron. In the illustrated embodiment, shield 60 is formed out of a cold-rolled low-carbon steel having a carbon content within the range of 0.15% to 0.20% (by weight) such as AISI (American Iron and Steel Institute) 1018 cold-rolled steel. Shield member 60 is a sheet material having opposing major surfaces that are substantially parallel with each other and wherein the surface area of the major surfaces defines a substantial majority of the surface area of the sheet material with the edges being relatively small in comparison. The thickness of the sheet material between the two opposing major surfaces is substantially constant and consistent and, in the illustrated embodiments falls within the range of 0.5 mm and 2.5 mm, however, other thicknesses may also be used.

The plurality of high current conductors 42 which convey electrical current between inverter circuitry 40 and stator windings 26 extend axially from proximate the heat sink 50 where power modules 52 are mounted on the outer radial surface of heat sink 50 to stator assembly 22. High current conductors 42 are positioned radially outwardly of magnetic position sensor 48 and angularly distributed about the rotational axis 34. Shield member 60 is positioned such that inverter circuitry 40 is on one side of shield member 60 and the axial plane 70 defined thereby and the printed circuit board 46, magnetic position sensor 48 and target magnet 36 are on the other side. This positioning places a significant portion, but not all, of the axially extending length of high current conductors 42 on an opposite side of shield 60 than magnetic position sensor 48 and target magnet 36. As discussed above, it is this axially extending length of conductors 42 that generates a significant amount of stray magnetic fields that might interfere with the operation of magnetic position sensor 48. Shield member 60 captures and redirects much of these stray magnetic fields. Shield member 60 is disposed in axial plane 70 which is axially displaced from magnetic position sensor 48, target magnet 36 and the space between magnetic position sensor 48 and target magnet 36. Thus, by capturing and redirecting stray magnetic fields within axial plane 70, shield 60 prevents (or greatly reduces) such redirected stray magnetic fields from interfering with the operation of magnetic position sensor 48 and thereby improves the accuracy of magnetic position sensor 48.

Compared to prior art flux concentrators which have a footprint comparable in size to the magnetic position sensor, shield member 60 has a major surface 66 defining a surface area that is significantly larger than the footprint of the magnetic position sensor 48. In this regard, it is noted that the position of the main contributors to stray magnetic fields, high current conductors 42 is particularly relevant when selecting the size of shield member 60. High current conductors 42 are arranged such that each conductor 42 defines a radially inward facing surface 43 and a circle 41 drawn in axial plane 70 which is concentric with rotational axis 34 and has a radius equal to the nearest one of the radially inward facing surfaces 43 will define a surface area. In the illustrated embodiment, each of the high current conductors are spaced from rotational axis 34 by the same distance and, thus, the circle 41 defined by the closest one of the radially inward facing surfaces connects all three of the radially inward facing surfaces 43, and typically will have its center point aligned with (or at least proximate to) the center of the magnetic position sensor device. It is noted that this radial distance to the radial inward facing surfaces of the high current conductors will generally be at least as great as the radial dimension of the rotor assembly and will generally correspond to the radial dimension of the stator assembly because such high current conductors need to extend to a position where they can be coupled with the stator windings. In the illustrated embodiment, the radially inward facing surfaces 43 correspond to the radially innermost edge of welding tabs 51 used to connect power modules 52 with a bus bar extending to stator windings 26.

By using a shield member 60 having a major surface 66 with a surface area that is at least 50% of the area of circle 41, a significant amount of the stray magnetic fields being generated by high current conductors 42 can be captured and redirected by shield 60. This larger surface area is necessary to both capture and redirect the stray magnetic fields. It is not only the total surface area of shield member 60 that impacts this ability but also the distribution of that surface area. As mentioned above, shield member 60 defines a plurality of openings 62 that allow heat sink pedestals to pass through shield member 60 and engage printed circuit board 46. While openings 62 reduce the surface area of shield member 60, it is thought that a shield having a larger diameter will generally perform better than a smaller diameter shield of the same surface area. Advantageously, and as best seen in FIG. 21, shield member 60 has an outer perimeter 65 that defines a circle wherein the diameter 67 of the circle defined by outer perimeter 65 is at least as great as 85% of the diameter 45 of circle 41 defined by high current conductors 42. In this regard, it is noted that outer perimeter 65 does not necessarily have to be a perfect circle and some of the openings in shield 60 may be present at the outer perimeter and thus alter the perimeter from being a perfect circle. In the embodiment of FIG. 21, outer perimeter 65 defines a diameter 67 that is 85% of diameter 45 of circle 41 and major surface 66 of shield member 60 is approximately 67% of the area of circle 41.

FIG. 9 presents a chart of dynamometer tested results for several different shield configurations. The vertical axis corresponds to the unwanted variation in the rotations per minute (RPM) of the rotating electric machine when it is being operated as a motor at 3600 RPM. This unwanted variation is measured as a percentage of a baseline wherein the baseline is the unwanted variation in RPM experienced by a rotating electric machine of the same design but without a magnetic shield member. Thus, lower percentage values are indicative of superior shielding properties. The horizontal axis corresponds to the torque being generated by the rotating electric machine at 3600 RPM. In FIG. 9, the shield labelled #8 has a surface area that is less than 50% of the area of the circle defined by the high current conductors 42 and behaves more like a flux concentrator (i.e. similar to the prior art) than a magnetic shield and had the poorest results. The shield labelled #7 had the center portion of the shield which directly covers the magnetic position sensor, which can act as a flux concentrator for the magnetic position sensor, removed but the configuration of shield #7 is otherwise similar to the shield labelled #9. A comparison of the performance of shields #7 and #9 show that at high torques, when the current through the high current conductors 42 will be significant, the difference in performance between shields #7 and #9 is minimal. At lower torques, shield #9 performed significantly better than shield #7. This is believed to be due, at least in part, to the flux concentrating effects of that portion of shield #9 that directly overlies magnetic position sensor 48 and which is missing from the center of shield #7. The shield labelled #5 performs similarly to shield #9 and slightly better at very low and very high torques. Shield #5 has a greater surface area than shield #9 with that greater surface area being located near the outer perimeter of the shield. To provide this greater surface area, the cutouts for the heat sink pedestals in shield #5 are more complex thus adding manufacturing complexity and cost in comparison to shield #9.

FIGS. 16 and 18 illustrate an embodiment having a heat sink 150 having a main body 156 that defines a recess 152 in which shield member 160 is disposed. Shield member 160 has a planar first portion 162 that defines axial plane 70 and a second portion 164 that is axially displaced from first portion 162 toward magnetic position sensor 48. The sheet material used to manufacture shield member 160 can be pressed or stamped to displace and form second portion 164. The planar first portion 162 forms a majority of shield member 160 and is disposed in recess 152. Second portion extends from the first portion 162 toward printed circuit board 46 and, in the illustrated embodiment, extends a sufficient axial distance that the central section of second portion 164 is located outside recess 152.

Mounting shield member 160 in recess 152 provides certain manufacturing efficiencies during assembly and also facilitates the manufacture of a rotating electric machine with a shorter axial length. Locating shield 160 in recess 152, however, can result in shield 160 being located further from printed circuit board 46 which slightly decreases its effectiveness. To counteract this loss of effectiveness, second portion 164 is displaced towards magnetic position sensor 48 whereby it acts like a flux concentrator for magnetic position sensor 48. In this regard, it is noted that second portion 164, magnetic position sensor 48 and target magnet 36 are all positioned concentrically with rotational axis 34 and axially spaced apart from each other with magnetic position sensor 48 being disposed between second portionn 164 and target magnet 36.

Shield member 160 is secured with four threaded fasteners 166 which engage threaded bores in heat sink 150, however, a different number (e.g., three) or type (e.g., rivets) of fastener, and/or alternative methods (e.g., adhesives) may also be used, either singularly or in combination.

While this invention has been described as having an exemplary design, the present invention may be further modified within the spirit and scope of this disclosure. This application is therefore intended to cover any variations, uses, or adaptations of the invention using its general principles.

What is claimed is:

1. A rotating electric machine comprising:
a stator assembly including a stator core and a plurality of stator windings;
a rotor assembly including a rotor mounted on a rotor shaft, the rotor shaft and rotor being rotatable relative to the stator assembly about a rotor axis;
a target magnet mounted on a proximal end of the rotor shaft;
inverter circuitry adapted to convert electrical current between DC electrical current and AC electrical current wherein the inverter circuitry is conductively coupled with the plurality of stator windings through a plurality of high current conductors;
control circuitry mounted on a printed circuit board and controlling operation of the inverter circuitry;
a non-ferrous heat sink, the heat sink being thermally coupled with the inverter circuitry;
a magnetic position sensor mounted on the printed circuit board facing the target magnet to thereby sense the rotational position of the target magnet during operation of the rotating electric machine;
wherein the printed circuit board is axially positioned between the target magnet and the heat sink and the plurality of high current conductors extend axially from proximate the heat sink to the stator assembly and are positioned radially outwardly of the magnetic position sensor and angularly distributed about the rotational axis;
a shield member formed out of a ferrous sheet material and having a major surface defining an axial plane perpendicular to the rotational axis and a first surface area wherein the printed circuit board and magnetic position sensor mounted thereon are axially disposed between the shield member and the target magnet and wherein the shield member is disposed proximate the printed circuit board and is axially disposed between the printed circuit board and at least a portion of the heat sink; and
wherein the plurality of high current conductors each define a radially inward facing surface wherein a circle drawn in the axial plane, concentric with the rotational axis and having a radius equal to a distance between the rotational axis and a nearest one of the radially inward facing surfaces of the plurality of high current conductors defines a second surface area, the first surface area being at least as great as 50% of the second surface area.

2. The rotating electric machine of claim 1 wherein the shield member defines a plurality of openings and the heat sink defines a plurality of pedestals axially extending from the main body of the heat sink through the plurality of openings in the shield member, each of the pedestals being thermally coupled with the printed circuit board.

3. The rotating electric machine of claim 2 wherein the outer perimeter of the shield member defines a circle having a first diameter and wherein the circle defined by the radially inward facing surfaces of the plurality of high current conductors defines a second diameter, the first diameter being at least as great as 85% of the second diameter.

4. The rotating electric machine of claim 2 wherein the main body of the heat sink defines a recess and the shield member is at least partially disposed in the recess.

5. The rotating electric machine of claim 4 wherein the shield member includes a planar first portion disposed in the axial plane and a second portion axially displaced from the first portion toward the magnetic position sensor, the first portion being disposed in the recess and the second portion being at least partially disposed outside the recess and wherein the second portion, the target magnet and the magnetic position sensor are all positioned concentrically with the rotational axis and axially spaced apart from each other with the magnetic position sensor being disposed between the second portion and the target magnet.

6. The rotating electric machine of claim 5 wherein the first portion of the shield member forms a majority of the shield member.

7. The rotating electric machine of claim 1 wherein the shield member is secured to the heat sink.

8. The rotating electric machine of claim 1 wherein the shield member has a thickness within the range of 0.5 mm to 2.5 mm.

9. The rotating electric machine of claim 1 wherein the shield member is selected from the group consisting of a carbon steel having a carbon content up to 2.1% (by weight), an electrical steel having a silicon content within the range of 1% to 6.5% (by weight) and a permalloy comprising both nickel and iron.

10. The rotating electric machine of claim 9 wherein the shield member is a cold-rolled low-carbon steel having a carbon content of 0.18% (by weight).

11. The rotating electric machine of claim 10 wherein the shield member has a thickness within the range of 0.5 mm and 2.5 mm.

12. A rotating electric machine comprising:
a stator assembly including a stator core and a plurality of stator windings;
a rotor assembly including a rotor mounted on a rotor shaft, the rotor shaft and rotor being rotatable relative to the stator assembly about a rotor axis;
a target magnet mounted on a proximal end of the rotor shaft;
inverter circuitry adapted to convert electrical current between DC electrical current and AC electrical current wherein the inverter circuitry is conductively coupled with the plurality of stator windings through a plurality of high current conductors;
control circuitry mounted on a printed circuit board and controlling operation of the inverter circuitry;
a non-ferrous heat sink, the heat sink being thermally coupled with the inverter circuitry;
a magnetic position sensor mounted on the printed circuit board facing the target magnet to thereby sense the rotational position of the target magnet during operation of the rotating electric machine;
wherein the printed circuit board is axially positioned between the target magnet and the heat sink and the plurality of high current conductors extend axially from proximate the heat sink to the stator assembly and are positioned radially outwardly of the magnetic position sensor and angularly distributed about the rotational axis;
a shield member formed out of a ferrous sheet material and having a major surface defining an axial plane perpendicular to the rotational axis and a first surface area wherein the printed circuit board and magnetic position sensor mounted thereon are axially disposed between the shield member and the target magnet, and wherein the shield member is disposed proximate the printed circuit board and is axially disposed between the printed circuit board and at least a portion of the heat sink; and
wherein the shield member includes a planar first portion disposed in the axial plane and a second portion axially displaced from the first portion toward the magnetic position sensor, the first portion of the shield member forming a majority of the shield member and wherein the second portion, the target magnet and the magnetic position sensor are all positioned concentrically with the rotational axis and axially spaced apart from each other with the magnetic position sensor being axially disposed between the second portion and the target magnet.

13. The rotating electric machine of claim 12 wherein the first portion of the shield member defines a plurality of openings and the heat sink defines a plurality of pedestals axially extending from the main body through the plurality of openings in the shield member, each of the pedestals being thermally coupled with the printed circuit board.

14. The rotating electric machine of claim 13 wherein an outer perimeter of the first portion of the shield member defines a first circle having a first diameter and the plurality of high current conductors each define a radially inward facing surface wherein a second circle drawn in the axial plane, concentric with the rotational axis and connecting each of the radially inward facing surfaces of the plurality of high current conductors defines a second diameter, the first diameter being at least as great as 85% of the second diameter.

15. The rotating electric machine of claim 14 wherein the second circle defines a second surface area, the first surface area being at least as great as 50% of the second surface area.

16. The rotating electric machine of claim 15 wherein the main body of the heat sink defines a recess and the first portion of the shield member is disposed within the recess and at least a portion of the second portion of the shield member is disposed outside the recess.
